(19) United States
(12) Patent Application Publication
(10) Pub. No.: US 2010/0068899 A1
(43) Pub. Date: Mar. 18, 2010

(54) Lighting System

(76) Inventor: Asher Shvili, Bat-Yam (IL)

Correspondence Address: The Law Office of Michael E. Kondoudis, 888 16th Street, N.W., Suite 800, Washington, DC, 20006, US

(21) Appl. No.: 12/529,488

(22) PCT Filed: Feb. 28, 2008
(86) PCT No.: PCT/IL08/00262

§ 371 Date: Sep. 1, 2009

(30) Foreign Application Priority Data
Mar. 1, 2007 (IL) 181653

(51) Int. Cl. H01R 11/30

(52) U.S. Cl. 439/39

(57) ABSTRACT

A lighting system comprising a socket, a light fixture and a magnetic holding mechanism. The magnetic holding mechanism may be removably or integrally attached to the socket. The magnetic holding mechanism may be situated at the inner walls of the cavity created by the socket close to the socket's opening; and the light fixture comprises at least one magnetic coupler enabling to magnetically couple to the magnetic holding mechanism's coupler, once the mechanism is attached to the socket and the light fixture is inserted into the socket and couples to the magnetic holding mechanism. The socket may hold the light fixture's weight by the magnetic force attracting the couplers.

### CROSS REFERENCE TO RELATED APPLICATION

This application claims the benefit of IL Patent Application number 181653 filed Mar. 1, 2007, which is incorporated herein by reference.

### FIELD OF THE INVENTION

The present invention relates to lighting systems comprising a light bulb and socket, and techniques for retaining the light bulb in the socket.

### BACKGROUND OF THE INVENTION

Incandescent lamps (e.g. light bulbs) and other light fixtures such as halogen or fluorescent lamps have to connect to electric power sources usually arriving from the main power supply of the facility (e.g. the house and rooms, building etc.) through electric wirings. Each lamp type and design usually has its own suited lamp socket adapted to receive and hold the lamp as well as to connect the lamp to the electrical wiring.

To allow optimal distribution of light in a space in which the lamp(s) is installed (e.g. a room), the sockets are usually installed in high areas (usually above the average human height) such as on the ceiling or at the top part of a room's wall.

FIG. 1 and FIG. 2 illustrate a standard, prior art incandescent lighting system 50, according to the known art. The standard system 50 usually comprises a standard light bulb 10 and a standard socket 20.

The incandescent light bulb 10 may have a male-threaded base, and a glass bulb 17 enclosing the bulb's 10 filament 15. The socket 20 has a female-threaded cavity 21 for receiving the base of the light bulb 10. The incandescent light bulb 10 is a two-terminal electrical device. The light bulb 10 base has a contact 12 at the end of the base, opposite the bulb 10, and the threaded wall 13 of the base forms the other of the two contacts. Similarly, the socket 20 has a contact 23 at the center of the female-threaded cavity 21, and another contact 22 disposed on (or forming the entire) sidewall of the female-threaded cavity 21. The standard incandescent light bulb 10 is typically powered by alternating, household current, which is provided by wiring 28 (two conductors) connected to the two contacts 22 and 23 of the socket 20.

Replacing a lamp that is situated in high places such as the ceiling or the top end of a wall may be a cumbersome and tedious task, since a user, assigned to do that task, is required to screw the lamp into the socket while he is supported by dangerous lifting and supporting devices (e.g. a ladder) that allow him to reach the lamp's height.

Additionally, the threading of the light bulb into its corresponding socket may erode the inner electric contacts especially the sided one that contacts the treaded contact of the light bulb.

French patent number FR2868883 discloses a device that has a socket with a permanent magnet insulated from electrical connection units by plastic surrounding. The magnet can be connected to a magnetic base of a bulb to guide and hold the base in position with a minimum gap. An adapter is screwed on the base of the bulb having a magnetic support perforated at its center to allow a passage for a guide pin towards a central electrical contact of the socket. The base of the bulb is situated at the edge of the male threaded portion of the bulb.

In the French patent, the magnet is situated at the base of the socket near the electric connections where the adaptor (that is a metal or a magnet enabling to couple to the magnet) is situated adjacent the electric contact of the light bulb at the edge of the treaded portion. This may be quite cumbersome to manufacture and quite dangerous, since the electric wiring of the socket are quite close to the magnet and the cover material insulating the contacts from the magnet may erode the electric contacts. The proximity of the magnets to the electric contacts may also endanger the electric conductivity since certain directions of the magnetic force applied by the magnets may create an induced current that may interrupt the electrical current operating the light bulb.

### SUMMARY OF THE INVENTION

The present invention discloses, in some embodiments thereof, a lighting system comprising a socket, a light fixture, and a magnetic holding mechanism.

The socket and said light fixture may comprise electric contacts allowing to electrically operate said light fixture once said contacts are connected, as known in the art.

According to some embodiments of the invention, the magnetic holding mechanism may be attached to a circumference of said socket that is close to an open edge of said socket; and said light fixture may comprise at least one magnetic coupler enabling to magnetically couple to said magnetic holding mechanism. The magnetic coupler of the light fixture and the magnetic holding mechanism may be separated from the electric contacts of said socket.

Additionally, the magnetic holding mechanism may be capable of holding said light fixture's weight by a magnetic force created by magnetic coupling of said magnetic holding mechanism and said magnetic coupler 110 once the magnetic holding mechanism is attached to the socket and once the light fixture is coupled to the magnetic holding mechanism.

According to some embodiments of the invention, at least one of: said magnetic coupler and said magnetic holding mechanism, is made from permanent magnet.

According to some embodiments of the invention, the light fixture may additionally comprise a light bulb comprising a filament; and a base comprising a first electric contact; and a second electric contact. The base and the light bulb may be integrated. Additionally, the socket may further comprise a housing; a first electric contact; and a second electric contact. The contacts may allow conducting electric current to operate said light fixture by closing a circuit, wherein the second contact of said light fixture may be a cylindrical conductor.

According to some embodiments of the invention, the first contact of said socket may be situated at the center of the inner walls of said socket and, respectively, the first contact f said light fixture may be situated at the center of a base of said light fixture. Additionally, the second contact of said socket may be situated at the side of the inner walls of the cavity created by said socket and, respectively, said second contact of said light fixture may be situated at the external circumference walls of said base of said light fixture.

According to some embodiments of the invention, the light fixture may additionally comprising an isolating divider, which enables isolating and resisting electric conductivity, separates the first contact from the second contact. The second electric contact of said light fixture may be a conductive coating layer covering a circumference neck like shape of the base of said light fixture.

According to some embodiments of the invention, the magnetic holding mechanism and the light fixture's magnetic coupler may be magnetic rings coaxially engaged with one another wherein said light fixture may be inserted into said socket.

According to some embodiments of the invention, the ring magnetic holding mechanism and said coupler may be coaxially engaged in a in a coplanar manner sharing the same planar surface.

According to some embodiments of the invention, the magnetic ring holding mechanism may be attached to the socket's circumference inner walls, where said magnetic ring coupler of said light fixture is attached to said light fixture's circumference outer walls.

According to some embodiments of the invention, the magnetic ring holding mechanism may be attached to the socket's circumference outer walls, where said magnetic ring coupler of said light fixture is attached to said light fixture's circumference inner walls.

According to some embodiments of the invention, the light fixture further comprises a separating layer, which separates said conductive layer of said second contact of said light fixture and said magnetic coupler f said light fixture, to facilitate in electrically isolating said second contact from said magnetic coupler.

According to some embodiments of the invention, the magnetic coupler that attaches to said socket may be a retrofit piece that may attach to circumferential inner or outer walls of said socket.

According to some embodiments of the invention, he lighting system may additionally comprise an extension device for facilitating a user in replacing light fixtures using the same socket when said socket is attached to a high area wall, such as the ceiling. The extension device may be a longitudinal rod comprising: a rod and a light bulb holder. The rod may be a longitudinal cylindrical object and the holder may be situated at one end of said rod enabling to hold and grab a light fixture enabling the user to reach the high and distant socket and to remove and install light fixtures to said socket.

According to some embodiments of the invention, the rod may be telescopic comprising modular pieces that allow defining the length of said extension device according to the distance between the user and said socket.

According to some embodiments of the invention, the holder of the extension device may comprise two fasteners, a spring mechanism and a bolt, where said fasteners may be connected to the spring mechanism and the spring mechanism may be connected to the bolt. Upon moving said bolt, the spring mechanism may enable decreasing the aperture between said fasteners where by said fasteners enable grabbing said light fixture.

According to some embodiments of the invention, the magnetic holding mechanism may be a removable retrofit, which comprises: said magnetic element, a male threaded element integrally connected to an isolating layer, a first opening and a second opening. The removable retrofit magnetic holding mechanism may enable to be screw-threaded to a standard socket comprising a female threaded cavity, where the male threaded element of said magnetic holding mechanism may be fit to be threaded into the female threaded cavity of said standard socket. Additionally the magnetic element may be integrally attached to the external circumference of the male threaded element allowing magnetically coupling to the light fixture's magnetic coupler.

According to some embodiments of the invention, the removable retrofit magnetic holding mechanism may be a hollow cylinder where the first and the second openings allow inserting the base of the light fixture through the magnetic holding mechanism to enable the first contact of the light fixture to contact the first contact of the socket. Additionally, the male threaded element may be made from electrically conductive materials allowing to electrically connect the second contact of the socket with the second contact of the light fixture.

According to some embodiments of the invention, the lighting system may additionally comprise at least one indicators enabling to indicate when the light fixture is safely secured in said socket. A part of the base of said light fixture may be marked by a marking layer, wherein said indicator enables a user to view the marked layer through said indicator only when the light fixture is rightly inserted into the socket's cavity and only when the magnetic coupler of the light fixture is safely coupled to the magnetic holding mechanism that is attached to the socket.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein:

FIG. 1 is a schematic illustration of a side cross-section view of a standard light bulb threaded into a standard lamp socket, according to prior art;

FIG. 2 is a schematic illustration of a bottom view of a standard lamp socket, according to prior art;

FIG. 3 is a schematic illustration of a side cross-section a magnetic lighting system, according to some embodiments of the invention;

FIG. 4 is a schematic illustration of a side cross-section view of a light fixture attached to lamp socket through a magnetic fastening mechanism, according to some embodiments of the invention;

FIG. 5 is a schematic illustration of an extension device for removing and installing of a light fixture from and into a socket, according to an embodiment of the invention;

FIG. 6 is an isometric view of a lighting system with coaxially engaged magnetic coupling members, according to some embodiments of the invention;

FIG. 7 is an exploded cross section view of a lighting system with a removable magnetic holding mechanism, according to some embodiments of the invention; and

FIG. 8 is an exploded cross section view of a lighting system with a connection-indicating mechanism, according to some embodiments of the invention.

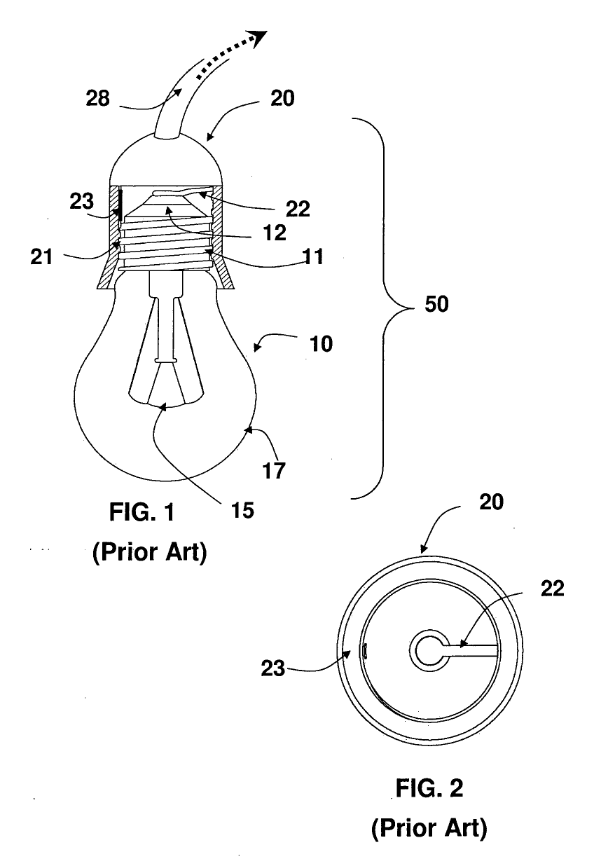

The drawings together with the description make apparent to those skilled in the art how the invention may be embodied in practice.

### DETAILED DESCRIPTIONS OF SOME EMBODIMENTS OF THE INVENTION

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention discloses, in some embodiments thereof, a lighting system 500 comprising a socket 200, a light fixture 100 and a magnetic holding mechanism 300 where the socket 200 and the light fixture 100 comprise electric contacts (220, 230, 120, 130) allowing to electrically operate the light fixture 100 once the contacts 220, 230 of the socket 200 are connected to corresponding contacts 120, 130 of the light fixture 100.

The magnetic holding mechanism 300 may be at least one magnetic coupler (e.g. a magnetic ring) enabling to attract or be attracted to a magnetic material (e.g. another magnet or a metallic ferromagnetic substance). The magnetic holding mechanism 300 may be removably or integrally attached to the circumference of the outer or the inner walls of the socket 200 close to the opening of the socket 200.

The light fixture 100 may comprise at least one magnetic coupler 110 enabling to magnetically attract to the magnetic holding mechanism 300, once the light fixture 100 is inserted into the socket 200 and once the magnetic holding mechanism 300 is attached to the socket 200.

The socket 200 attached to the magnetic holding mechanism 300 may hold the light fixture's 100 weight by the magnetic force of the magnetic coupling of the magnetic holding mechanism 300 and the light fixture's magnetic coupler 110. The mounting and de-mounting of the light fixture 100 to and from the socket 200 may be carried out by simply attaching the magnetic coupler 110 of the light fixture 100 to the magnetic holding mechanism 300 that is attached to the socket 200, without the necessity to thread the light fixture 100 to the socket 200.

The magnetic force that magnetically attracts the coupler 110 and the magnetic holding mechanism 300 to one another may counteract the gravitational force applied by the weight of the light fixture 100 and withstand some potential transient forces such as shock, bumping, etc. The magnetic force may be larger than the gravitational force enabling holding the light fixture 100 in the socket 200, where the socket 200 is held affixed to a heightened surface (e.g. ceiling, wall etc.).

According to some embodiments of the invention, once coupled, the coupler 110 and the magnetic holding mechanism 300 may be separated from the electric contacts 220 and 230 of the socket 200 creating a substantial distance between the contacts 220 and 230 of the socket 200 and the magnetic coupler 110 and magnetic holding mechanism 300.

The magnetic coupler 110 may be any magnetic material (preferably a permanent magnet) enabling to apply a magnetic force that attracts the magnetic holding mechanism 300.

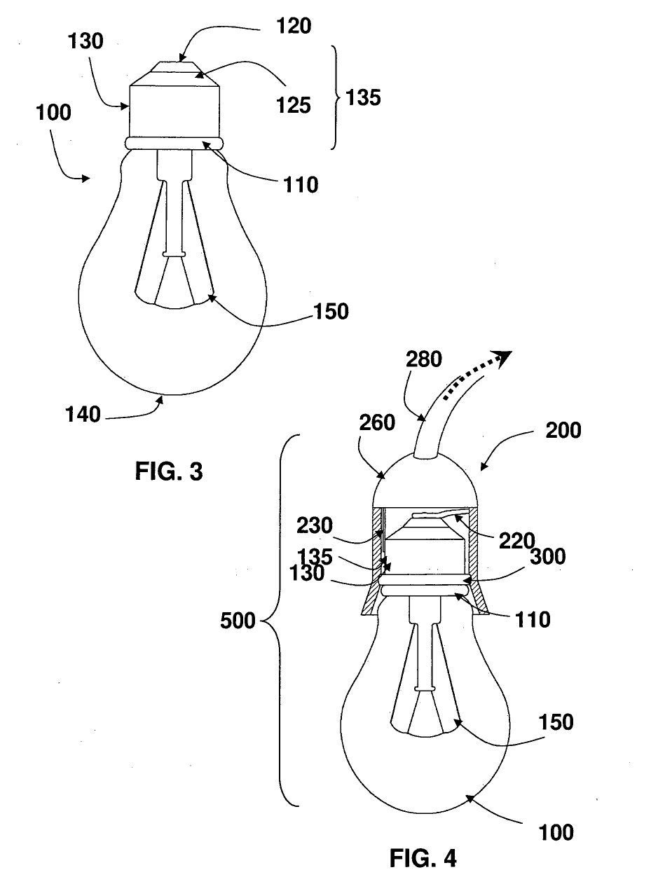

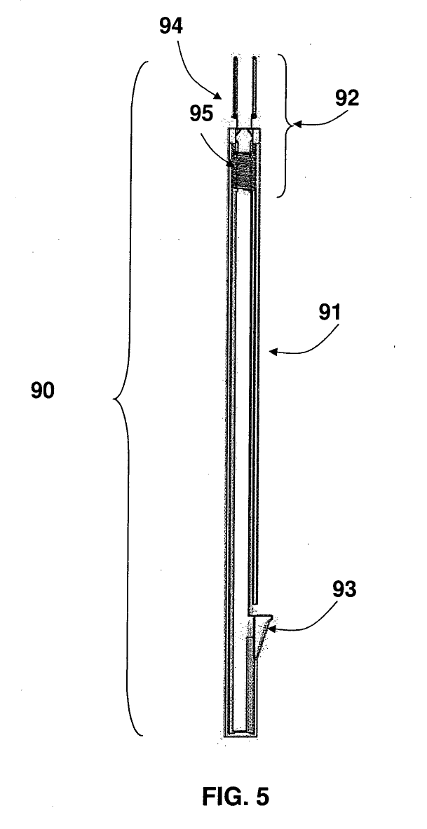

FIG. 3 and FIG. 4 are schematic illustrations of a lighting system 500, according to some embodiments of the invention.

According to these embodiments, the system 500 may comprise a light fixture 100; a magnetic holding mechanism 300 and a suitable socket 200, where the socket 200 may connect to an electric power through wirings 280 that may also enable affixing the socket 200 to a heightened surface (e.g. a ceiling).

The light fixture 100 may be any illuminating device, such as an incandescent light bulb, a fluorescent lamp or a neon lamp, and the like.

According to some embodiments of the invention, as illustrated in FIG. 4, the socket 200 may comprise a housing 260 made from solid materials such as heat resistant plastics or perspex, for example; and a first and a second electric contacts 220 and 230 respectively.

The magnetic holding mechanism 300 may be integrally attached to the circumferential inner/outer walls of the socket 200.

According to some embodiments of the invention, as illustrated in FIG. 3 and FIG. 4, the light fixture 100 may comprise a glass light bulb 140 comprising a filament 150; a first contact 120 (which may be of any design and shape according to the cavity shape of the inner walls of the socket 200 such as substantially cylindrical or polygonal shape, for example); a second contact 130 situated at a base 135 of the light fixture 100 (at the center of the top of the light fixture 100); and at least one magnetic coupler 110.

The cavity of the socket 200 is generally cylindrical, having a closed end and an open end for receiving the base 135 of the light fixture 100.

The socket 200 may be a three dimensional object creating a cavity that enables receiving the base 135 of the light fixture 100, where the magnetic holding mechanism 300 may be integrally attached to the inner walls of the circumference near the walls of the socket's 200 opened end. The first contact 130 of the light fixture 100 may be situated at the end of the base 135, where the second contact 130 may be encircling the base 135 where an isolating divider 125 may separate the two contacts 120 and 130 preventing them from electrically interact with one another.

The lighting system 500 is typically powered by alternating, household current, which is provided by wiring 280 conducting electricity to the socket's 200 contacts 220 and 230.

According to some embodiments of the invention, the open end of the socket 200 may be flared outward to allow for easy insertion of the light fixture 100 into the cavity of the socket 200.

The electric contacts 220 and 230 may conduct electric current through a wiring 280 that connect to a main power supply.

According to some embodiments of the invention, the first electric contact 220 of the socket 200 may be situated substantially at the center of the inner walls of the socket's 200 inner walls, where the second electric contact 230 may be a substantially flexible tongue shaped conductor (e.g. metal leaf) situated at the side to the inner walls of the socket 200.

The couplers 110 and 310 may be separated from the electric contacts 220 and 230 of the socket 200, as illustrated in FIG. 4, creating a substantial distance between the contacts 220 and 230 of the socket 200 and the magnetic coupler 110 and coupled to the magnetic holding mechanism 300.

The magnetic couplers 110 and 310 of the light fixture 100 and the magnetic holding mechanism 300 attached to the socket 200 respectively may be positioned to allow magnetic coupling to one another once the light fixture 100 is inserted into the socket 200, as illustrated in FIG. 4.

At least one of the coupling members (either the magnetic coupler 110 or the magnetic holding mechanism 300) may be a magnet. For example, the magnetic holding mechanism 300 may be made from iron where the light fixture's 100 magnetic coupler 110 may be a permanent magnet. Alternatively, both the magnetic holding mechanism 300 and the magnetic coupler 110 may be made from a permanent magnet According to some embodiments of the invention, the coupler 110 and the magnetic holding mechanism 300 may be situated symmetrically around the main axis of the socket 200 and light fixture 100.

According to some embodiments of the invention, as illustrated in FIG. 3, FIG. 4, the magnetic coupler 110 and the magnetic holding mechanism 300 may be magnetic rings (e.g. a permanent magnet shaped as a ring) coaxially engaged when said light fixture 100 is inserted into the socket 200. The rings couplers 300 and 110 may be coupled to one another, where the magnetic attraction force is substantially along the same axis of the gravitational force applied by the weight of the lighting system 500. The magnetic coupler 110 of the light fixture 100 may be situated at the external circumference of the light fixture 100 at the base 135 of the contact 130, where the magnetic holding mechanism 300 may be situated at the circumferential inner side of the socket 200 that is close to the opening of the socket 200.

The two magnetic rings 110 and 300 may be designed (in terms of thickness, magnetic field intensity, diameters etc.) to allow the light fixture's 100 coupler 110, which is an external ring (to the light fixture 100) to magnetically couple to the magnetic ring holding mechanism 300, which integrally attaches to the inner walls of the socket 200.

According to some embodiments of the invention, the size, shape, length and positioning of the electric contacts 220 and 230 and their corresponding light fixture's 100 contacts 120 and 130 may be designed in such a way that allows the contact 220 to come in contact with or be engaged with the corresponding contact 120 of the light fixture 100 and the contact 230 to come in contact or be engaged with the corresponding contact 130 once the light fixture 100 is inserted into the cavity of the socket 200, as illustrated in FIG. 3 and FIG. 4.

For example, the first contact 220 of the socket 200 may be a tongue shape piece made from a conductive material (e.g. metal) that extends from the top side of the inner side of the socket 200 to the center of the top side. Correspondently, the contact 120 of the light fixture 100 may be a flat solid conductive palate situated at the top center of the light fixture 100 allowing touching the central part of the tongue shaped contact 220 of the socket. The second contact 230 of the socket 200 may be a tongue shaped leaf made from conductive solid materials that is situated at the inner side of the socket where some of the contact 230 may protrude inwardly towards the inner cavity of the socket 200. The contact 130 of the light fixture 100 may touch the protruding part of the second contact 230 once the light fixture 100 is inserted into the cavity of the socket 200 and once the two rings (holding mechanism 300 and coupler 110) are magnetically coupled to one another. Once the socket's 200 contacts 220 and 230 are attached to their corresponding light fixture's 100 contacts 120 and 130 they close an electric circuit.

The length and diameter or cross section area of a base 135 of the light fixture 100, where the contact 130 is situated, may be calculated and manufactured in correspondence with the diameter or cross section area and length of the socket 200 to allow the contacts 220 and 230 to engage with their corresponding first contact 120 and second contact 130, as illustrated in FIG. 4.

According to some embodiments of the invention, as illustrated in FIG. 3, the second contact 130 may be a cylindrical conductor that may not be threaded (e.g. may be of a substantially smooth surface), where the isolating divider 125, which enables isolating and resisting electric conductivity of the contacts 120 and 130, may separate the top central contact 120 from the second contact 130.

The couplers 110 and 120 may have any shape and size that allows them to magnetically couple to one another (and not necessarily ring shape).

According to some embodiments of the invention, the socket 200 may comprise additional fastening means to further secure the holding of the light fixture 100 such as, for example, retractable protrusions in the cavity of the socket 200 that can be opened once the light fixture 100 base 135 is inside the socket 200.

The size shape and magnetic attraction intensity between the magnetic couplers 110 and the magnetic holding mechanism 300 may be determined by the weight, shape and size of the light fixture 100 (e.g. the light fixture's 100 weight and the gravitational force produced thereof, may define a minimum threshold magnetic field above-which the holding of the light fixture 100 by the magnetic holding mechanism 300 may be secured).

The couplers 110 and 310 may be symmetrically positioned around the main axis of the socket 200 and the light fixture 100 once the magnetic holding mechanism 300 is attached to the socket 200 and the light fixture 100 is attached to the socket 200 and magnetic holding mechanism 300 (e.g. as rings, polygons or as segmented parts symmetrically positioned around the circumferences of the inner walls of the socket 200 and the outer walls the light fixture 100).

According to some embodiments of the invention, a separating layer may separate the encircling conductive layer of the second contact 130 of the light fixture 100 and the magnetic coupler 110. The separating layer may facilitate electrically isolating the second contact 130 from the magnetic coupler 110.

Alternatively, there may be no separating layer since the permanent magnetic coupler 110 may be electrically isolated from the contact 130.

According to some embodiments of the invention, as illustrated in FIG. 5, an extension device 90 may be used to facilitate the user in replacing light fixtures 100 using the same socket 200 and the same magnetic holding mechanism 300 that is attached to a high wall area or the ceiling, for example. The extension device 90 may comprise a rod 91 and a light bulb holder 92 (e.g. pliers, fasteners, etc.) where the rod 91 is a longitudinal object and the holder 92 is situated at one end of the rod 91 enabling to hold and grab light fixtures 100 once approximated to the socket 200 therefore enable the user to reach the high and distant socket 200 and to remove/install the light fixture 100. In a similar way, an existing light fixture 100 may be removed from the socket 200 by grabbing of the light fixture 100 using the bulb holder 92 and pulling the light fixture 100 from the socket 200.

According to some embodiments of the invention, as illustrated in FIG. 5, the holder 92 may comprise two fasteners 94, a spring mechanism 95 and a bolt 93. The fasteners 94 may be connected to the spring mechanism 95 and the spring mechanism 94 may be connected to the bolt 95. A user wishing to grab a light bulb fixture 100 (either to install or remove it to and from the socket 200) may push or move the bolt 93 along the rod 91 whereby the spring mechanism 95 may allow increasing or decreasing the aperture between the two fasteners 94. For example, in an increased aperture position the light fixture 100 held by the extension device 90 may be released (e.g. once secured by the magnetic coupling of 110 and 310 inside the socket 200 or once removed from the socket 200) and in a decreased aperture position the fasteners 94 may be able to grab the light fixture 100 to install it inside the socket 200 or to grab a light fixture 100 already secured to the socket 200 for the purpose of removing it from the socket 200.

According to some embodiments of the invention, the rod 91 may be telescopic comprising modular pieces that allow defining the length of the extension device 90 according to the distance between the user and the socket 200—mainly depending on the height the user is required to reach in order to remove and/or install the light fixture 100.

The bulb holder 92 may be any device known in the art that allows holding the bulb 110 of the light fixture 100 for attaching and detaching it to and from the socket 200 such as (i) pliers-based mechanism (e.g. tongs allowing opening and closing on the bulb object), and the like.

According to some embodiments of the invention, a part of the light fixture 100 may comprise a fastening mechanism adapted to the bulb holder 92 mechanism of the extension device 90 that allows the light fixture 100 to attach to the holder 92.

The light fixture 100 may be any type of lamp, light bulb or illuminating device known in the art such as, for example, incandescent lamps, neon, fluorescent or halogen lamps etc., whether electrically powered or not.

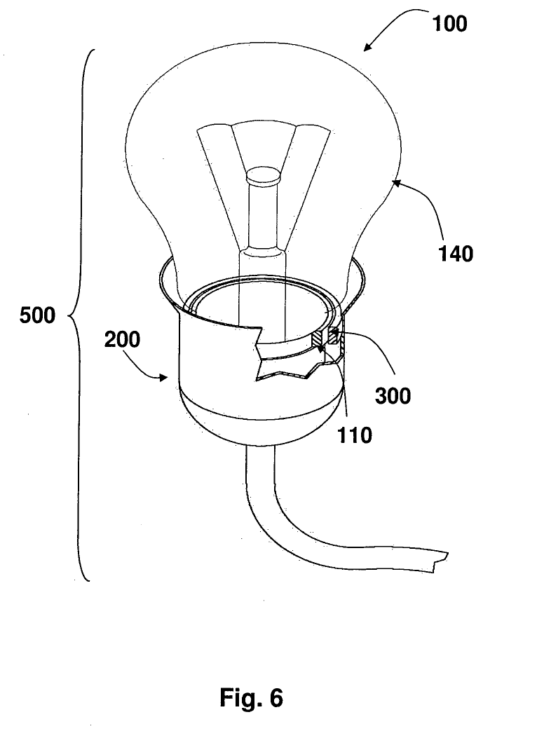

FIG. 6 schematically illustrates an isometric view of a lighting system 500 with coaxially engaged magnetic coupling members: magnetic holding mechanism 300 and magnetic coupler 110, according to some embodiments of the invention, where parts of the lighting system 500 are removed from the drawing for the purpose of revealing the inner construction of the rings of the lighting system 500.

According to these embodiments, the lighting system 500 illustrated in FIG. 6 is very similar to the other embodiments described and differs from them by the way in which the light fixture's 100 magnetic coupler 110 and the magnetic holding mechanism 300 are designed to engage one another. The rings of the magnetic members 300 and 110 enable coaxially engaging of the members 300 and 110, in a coplanar manner, where the ringed magnetic members 110 and 310 share the same planar surface and the same central axis. The ring of the magnetic holding mechanism 300 may be encircling the coupler 110 of the light fixture 110, as illustrated in FIG. 6. The diameter of the ring of the magnetic holding mechanism 300 may be larger than the diameter of the light fixture's 100 ring magnetic coupler 110, enabling the light fixture's 100 coupler 110 to be coaxially seated inside the ring of the magnetic holding mechanism 300.

In this configuration, where the magnetic members 110 and 300 are coaxially engaged in one another in a coplanar manner, the magnetic force of attracting the members 110 and 310 has to be radial (meaning that one pole of the magnets is at the center of the rings and the other is at a radial direction directing the magnetic force to be radial (either inwardly towards the center of the rings or outwardly towards the circumference of the rings). A mechanical force countering the gravitational force caused by the weight of the light fixture 100 holds the light fixture's 100 weight, where the mechanical force is applied along the same longitudinal vertical axis of the gravitational force applied by the light fixture's 100 weight. The mechanical force is caused by the magnetic force attracting the two ring magnetic members 110 and 300, where that magnetic force is perpendicular to the vertical axis of the gravitational force. The magnetic force, in this configuration is substantially perpendicular to the gravitational force applied by the weight of the light fixture 100.

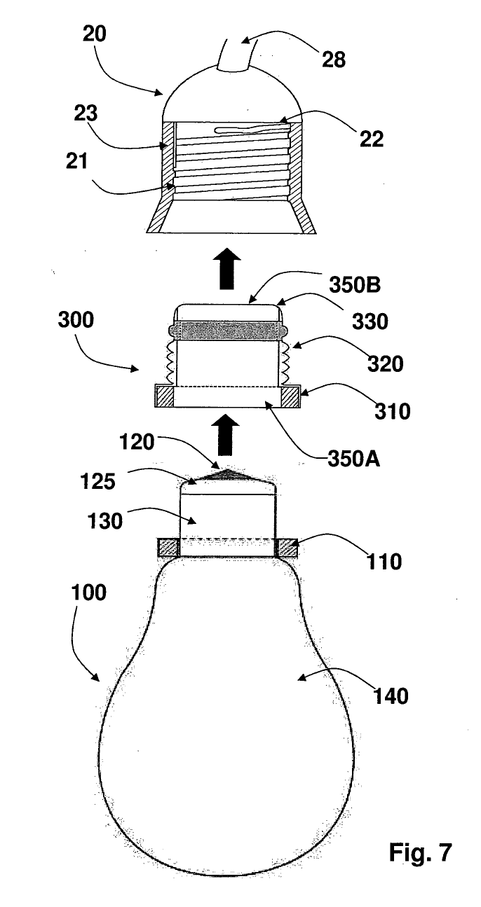

FIG. 7 is an exploded cross section view of a lighting system 500 with a removable retrofit magnetic holding mechanism 300, according to other embodiments of the invention. According to these embodiments, the magnetic holding mechanism 300 may be removable and may comprise: a male threaded element 320 integrally connected to an isolating layer 330, a magnetic element 310 a first opening 350A and a second opening 350B. The magnetic holding mechanism 300 may be a separate adaptor enabling to be screw-threaded to a standard socket 20 with a female threaded cavity 21, where the male threaded element 320 of the magnetic holding mechanism 300 is fit (in shape, size thread) to be threaded into the female threaded cavity 21 of the standard socket 20. The magnetic element 310 may be integrally attached to the external circumference of the male threaded element 320 allowing coupling to the light fixture's 100 magnetic coupler 110, as illustrated in FIG. 7.

To attach the magnetic holding mechanism 300, the male threaded element 320 may be screwed (threaded) to the female threaded cavity 21 of the socket 20.

The removable retrofit magnetic holding mechanism 300, illustrated in FIG. 7, may be a hollow cylinder where the first and the second openings 350A and 350B allow inserting the base 135 of the light fixture 100 through the magnetic holding mechanism 300 to enable the first contact 120 of the light fixture 100 to contact the first contact 22 of the standard socket 20. Additionally, the male threaded element 320 may be made from electrically conductive materials allowing to electrically connect the second contact 23 of the standard socket 20 with the second contact 130 of the light fixture 100.

The removable retrofit magnetic holding mechanism 300 may facilitate in avoiding replacing an existing standard socket 20 already installed in a high wall part such as a ceiling to use the magnetic coupling mechanism and the light fixture 100 with a magnetic coupler 110. Replacing the standard socket 20 with the system's 500 socket 200 or any other socket may be a cumbersome job requiring reconnecting electric wires that hang from the ceiling and the like. Using the removable retrofit magnetic holding mechanism 300 all the user is required to do in order to use the magnetically coupled light fixture 100 is to screw-thread the male threaded element 320 of the magnetic holding mechanism 300 to the female threaded cavity 21 of the standard socket 20 and then attach the light fixture 100 by simply coupling the magnetic coupler 110 of the light fixture 100 to the magnetic element 310 of the magnetic holding mechanism 300.

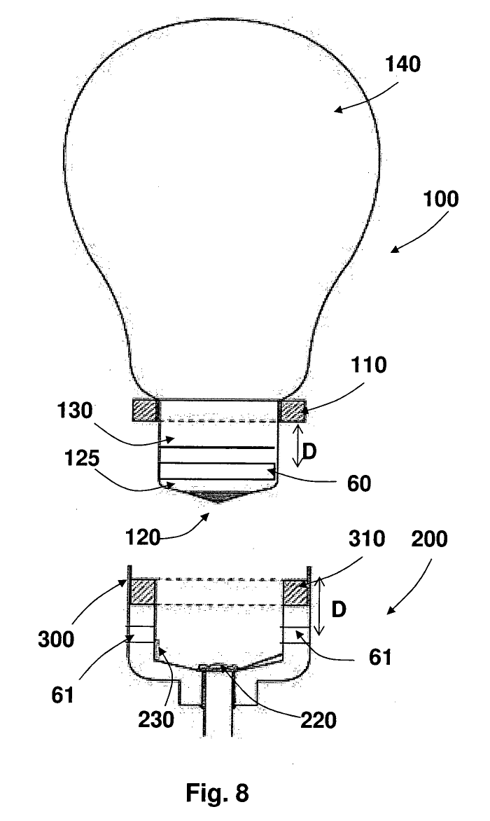

FIG. 8 is an exploded cross section view of a lighting system 500 with a connection-indicator, according to some embodiments of the invention.

The socket 200, in embodiments where the magnetic holding mechanism 300 is integrally attached to the socket 200, additionally comprises indicators 61 enabling to indicate that the base 135 of the light fixture 100 is safely secured in the socket 200. For example, a part of the second contact 120 at the base 135 of the light fixture 100 may be marked by a marking layer 60 (e.g. a stripe of color that is painted or attached over the second contact 120 or over the isolating divider 125 of the light fixture 100, where the indicator 61 of the socket 200 may be one or more windows in the socket 200 (e.g. parts of the socket 200 that are exposed openings or covered in transparent materials) enabling a user to view the marked layer 60 only when the light fixture 100 is rightly inserted to the socket's 200 cavity and only when the magnetic coupler 110 of the light fixture 100 is safely coupled to the magnetic holding mechanism 300 that is attached to the socket's 200 inner walls.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A lighting system 500 comprising a socket 200, a light fixture 100, and a magnetic holding mechanism 300,
wherein said socket 200 and said light fixture 100 comprise electric contacts allowing to electrically operate said light fixture once said contacts are connected;
wherein said magnetic holding mechanism 300 is attached to a circumference of said socket 200 that is close to an open edge of said socket 200; and
wherein said light fixture 100 comprises at least one magnetic coupler 110 enabling to magnetically couple to said magnetic holding mechanism 300, once said magnetic holding mechanism 300 is attached to said socket 200 and once said light fixture 100 is inserted into said socket 200;
wherein said magnetic coupler 110 and said magnetic holding mechanism 300 are separated from the electric contacts of said socket 200; and
wherein said magnetic holding mechanism 300 is capable of holding said light fixture's 100 weight by a magnetic force created by magnetic coupling of said magnetic holding mechanism 300 and said magnetic coupler 110.

2. The lighting system 500 of claim 1 wherein said magnetic holding mechanism 300 is integrally attached to the inner circumference of said socket 200 as an integrated part of said socket 200.

3. The lighting system 500 of claim 1 wherein at least one of: said magnetic coupler 110 and said magnetic holding mechanism 300, is made from permanent magnet.

4. The lighting system 500 of claim 1 wherein said light fixture 100 further comprises a light bulb 140 comprising a filament 150; and a base 135 comprising a first electric contact 120; and a second electric contact 130; and wherein
said socket 200 further comprises a housing 260; a first electric contact 220; and a second electric contact 230;
wherein said contacts allow conducting electric current to operate said light fixture 100 by closing a circuit,
wherein the second contact 130 of said light fixture 100 is a cylindrical conductor.

5. The lighting system 500 of claim 4 wherein said first contact 220 of said socket 200 is situated at the center of the inner walls of said socket 200 and, respectively, said first contact 120 of said light fixture 100 is situated at the center of the base 135 of said light fixture 100; and
wherein the second contact 230 of said socket 200 is situated at the side of the inner walls of the cavity created by said socket 200 and, respectively, said second contact 130 of said light fixture 100 is situated at the external circumference walls of said base 135 of said light fixture 100;
wherein said first electric contact 220 of said socket 200 contacts said first electric contact 120 of said light fixture 100 and said second electric contact 230 of said socket 200 contacts said second electric contact 130 of said light fixture 100 to enable closing an electric circuit whereby an electric current operates said light fixture 100.

6. The lighting system 500 of claim 4 wherein said light fixture 100 further comprising an isolating divider 125, which enables isolating and resisting electric conductivity, separates the first contact 120 from the second contact 130.

7. The lighting system 500 of claim 4 wherein said second electric contact 130 of said light fixture 100 is a conductive coating layer covering a circumference neck like shape of the base 135 of said light fixture 100.

8. The lighting system 500 of claim 4 wherein said magnetic holding mechanism 300 is a magnetic ring and the light fixture's 100 magnetic coupler 110 is a magnetic ring coaxially engaged with one another wherein said light fixture 100 is inserted into said socket 200.

9. The lighting system 500 of claim 8 wherein said ring magnetic holding mechanism 300 and said coupler 110 are coaxially engaged in a in a coplanar manner, wherein the couplers 110 and 310 share the same planar surface.

10. The lighting system 500 of claim 8 wherein said magnetic ring holding mechanism 300 is attached to the socket's 200 circumference inner walls; and
wherein said magnetic ring coupler 110 of said light fixture 100 is attached to said fixture's 100 circumference outer walls.

11. The lighting system 500 of claim 8 wherein said ring magnetic holding mechanism 300 is attached to the socket's 200 circumference outer walls; and
wherein said magnetic ring coupler 110 of said light fixture 100 is attached to said fixture's 100 circumference outer walls.

12. The lighting system 500 of claim 8 wherein said light fixture 100 further comprises a separating layer, which separates said conductive layer of said second contact 130 of said light fixture 100 and said magnetic coupler 110 of said light fixture 100, to facilitate in electrically isolating said second contact 130 from said magnetic coupler 110.

13. The lighting system 500 of claim 1 wherein said magnetic coupler 310 that attaches to said socket 200 is a retrofit piece that attaches to circumferential inner walls of said socket 200.

14. The lighting system 500 of claim 1 further comprising an extension device 90 to facilitate a user in replacing light fixtures 100 using the same socket 200 when said socket 200 is attached to a high area wall,
wherein said extension device 90 comprises a rod 91 and a light bulb holder 92 wherein said rod 91 is a longitudinal object and said holder 92 is situated at one end of said rod 91 enabling to hold and grab light fixtures 100 once approximated to said socket 200 therefore enabling the user to reach the high and distant socket 200 and to remove and install light fixtures 100 to said socket 200.

15. The lighting system 500 of claim 14 wherein said rod 91 is telescopic comprising modular pieces that allow defining the length of said extension device 90 according to the distance between the user and said socket 200.

16. The lighting system 500 of claim 14 wherein said holder 92 comprises two fasteners, a spring mechanism 95 and a bolt 93, wherein said fasteners 94 are connected to the spring mechanism 95 and the spring mechanism 94 is connected to the bolt 95,
wherein upon moving said bolt 93 the spring mechanism 95 enables decreasing the aperture between said fasteners where by said fasteners enable grabbing said light fixture 100.

17. The lighting system 500 of claim 4 wherein said magnetic holding mechanism 300 is a removable retrofit, which comprises: said magnetic element 310, a male threaded element 320 integrally connected to an isolating layer 330, a first opening 350A and a second opening 350B,
wherein said magnetic holding mechanism 300 enables to be screw-threaded to a standard socket 20 comprising a female threaded cavity 21, where the male threaded element 320 of said magnetic holding mechanism 300 is fit to be threaded into the female threaded cavity 21 of said standard socket 20 and wherein said magnetic element 310 is integrally attached to the external circumference of the male threaded element 320 allowing magnetically coupling to the light fixture's 100 magnetic coupler 110.

18. The lighting system 500 of claim 17 wherein said removable retrofit magnetic holding mechanism 300 is a hollow cylinder where the first and the second openings 350A and 350B allow inserting the base 135 of the light fixture 100 through the magnetic holding mechanism 300 to enable the first contact 120 of the light fixture 100 to contact the first contact of the socket 200 and wherein, the male threaded element 320 is made from electrically conductive materials allowing to electrically connect the second contact 230 of the socket 200 with the second contact 130 of the light fixture 100.

19. The lighting system 500 of claim 1 further comprises at least one indicators 61 enabling to indicate that said light fixture 100 is safely secured in said socket 200.

20. The lighting system 500 of claim 18 wherein a part of the base 135 of said light fixture 100 is marked by a marking layer 60, wherein said indicator 61 enables a user to view the marked layer 60 through said indicator only when the light fixture 100 is rightly inserted into the socket's 200 cavity and only when the magnetic coupler 110 of the light fixture 100 is safely coupled to the magnetic holding mechanism 300 that is attached to the socket 200.

21. A removable retrofit magnetic holding mechanism 300 for holding a light fixture 100 in a standard socket 20, wherein said light fixture 100 comprises a light bulb 140 connected to a base 135 comprising a fist contact 120 and a second contact 130; and
wherein said standard socket 20 creates a female threaded cavity 21 with an opening at one end and comprises a first and a second electric contacts enabling to contact said first and second contacts of said light fixture 100,
wherein said magnetic holding mechanism 300 comprises:
a magnetic element 310;
a male threaded element 320 an isolating layer 330; and
a first opening 350A and a second opening 350B;
wherein said male threaded element 320 is integrally connected to said isolating layer 330 and said a magnetic element 310 is attached to the edge of said male threaded element 320
wherein said magnetic holding mechanism 300 is capable of being screw-threaded to the standard socket's 20 female threaded cavity 21, and
wherein said magnetic element 310 enables magnetically coupling to the light fixture's 100 magnetic coupler 110, whereby said mechanism holds the weight of said light fixture 100.

22. The removable retrofit magnetic holding mechanism 300 of claim 21 is a hollow cylinder wherein the first and the second openings 350A and 350B allow inserting the base 135 of the light fixture 100 through said magnetic holding mechanism 300 to enable the first contact 120 of the light fixture 100 to contact the first contact 22 of the standard socket 20, and
wherein said male threaded element 320 is made from electrically conductive materials allowing to electrically connect the second contact 23 of the standard socket 20 to the second contact 130 of the light fixture 100.
